(19) United States
(12) Patent Application Publication
(10) Pub. No.: US 2009/0107530 A1
(43) Pub. Date: Apr. 30, 2009

(54) Sheet humidifying device and image forming apparatus provided therewith

(75) Inventors: Masashi Kougami, Saitama-shi (JP); Toshio Shida, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/150,849

(22) Filed: May 1, 2008

(30) Foreign Application Priority Data
Oct. 30, 2007 (JP) JP2007-281480

(51) Int. Cl. G03D 3/13

(52) U.S. Cl. 134/122 P; 134/122 R

(57) ABSTRACT

A sheet humidifying device includes: a humidifier having a pair of humidifying rollers which form a nip by being in contact with each other and humidify a sheet that passes through the nip; and a water supply tray which stores water to be supplied to the humidifier, having a wall forming a chamber that stores the water, and a water outlet causing the water to overflow from the chamber, which is formed on the wall.

This application is based on Japanese Patent Application No. 2007-281480 filed on Oct. 30, 2007, which is incorporated hereinto by reference.

### BACKGROUND OF THE INVENTION

The present invention relates to a sheet humidifying device that humidifies sheets and an image forming apparatus provided with the sheet humidifying device.

In an image forming apparatus of an electrophotographic type, namely, in a copying machine, a printer, a facsimile machine and a multifunction peripheral having functions thereof, there is a problem that a sheet is curled and is deformed to be corrugated because a sheet is dehydrated in the fixing process. As a means to solve this problem, there has been suggested a technology to humidify a sheet after the sheet is fixed.

Unexamined Japanese Patent Publication No. 11-161107 discloses a sheet humidifying device having therein a pair of humidifying rollers which convey a sheet and form a nip portion and a pair of water-supply rollers which are in contact with the humidifying rollers to supply water.

Water to be supplied to a sheet is supplied to the humidifying rollers from the water-supply rollers. Further, a supply of water to the water-supply rollers is conducted from a water-supply tray in Unexamined Japanese Patent Publication No. 11-161107, wherein, highly water-containing materials are arranged in the water-supply tray, and when the water-supply rollers come into contact with the water-containing materials to rotate, water is coated on the circumferential surface of the water-supply roller.

In a process of humidifying sheets, foreign matters such as paper dusts stick to humidifying rollers from sheets, then, stick to water-supply rollers from the humidifying rollers, and further foreign matters get mixed in with water in a water-supply tank that supplies water to the water-supply rollers.

In addition, foreign matters in the water-supply tank stick again to the water-supply rollers and to the humidifying rollers.

There is a problem that foreign matters on the humidifying rollers and the water-supply rollers prevent uniform humidification.

As in Unexamined Japanese Patent Publication No. 11-161107, there is a problem that foreign matters sticking to the highly water-containing materials prevent formation of uniform water film on the water-supply rollers in a humidifying device that supplies water to the water-supply rollers from the highly water-containing materials.

### SUMMARY OF THE INVENTION

An aspect of the invention is as follows.

A sheet humidifying device having therein a humidifier that has a pair of humidifying rollers that come in contact with each other to form a nip and humidify sheets passing through the nip and a water-supply tray storing water to be supplied to the humidifier, wherein the water-supply tray has walls which form a chamber to store the water, and a water outlet causing water to overflow from the chamber is formed on the wall.

Another aspect of the invention is as follows.

An image forming apparatus having an image forming apparatus main body that forms an image on a sheet and the sheet humidifying device described in the aforesaid one aspect that humidifies a sheet ejected from the image forming apparatus main body.

### BRIEF DESCRIPTION OF THE DRAWINGS

FIG. 1 is an overall diagram of an image forming apparatus relating to an embodiment of the invention.

FIG. 2 is an overall diagram of a sheet humidifying device in an embodiment of the invention.

FIG. 3 is a diagram showing the structure of a sheet humidifying section.

FIG. 4 is a perspective view of a water vessel.

FIG. 5 is a plan view of a water vessel.

FIG. 6 is a diagram showing an example wherein a water outlet on the upstream side and a water outlet on the downstream side are provided.

FIG. 7 is a diagram showing an example of an arrangement of a water inlet.

FIG. 8 is a diagram showing a decurl device.

### DETAILED DESCRIPTION OF THE PREFERRED EMBODIMENT

The invention will be explained in detail as follows, referring to the embodiment, to which, however, the invention is not limited.

### [Image Forming Apparatus]

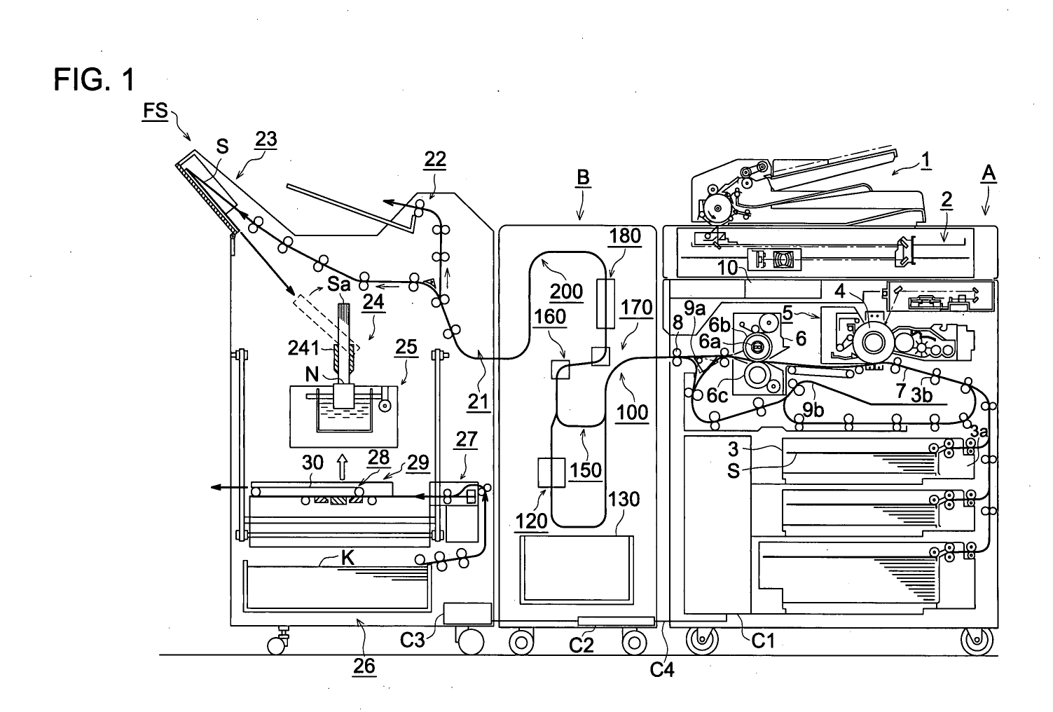

FIG. 1 is an overall diagram of an image forming apparatus relating to an embodiment of the invention, and the image forming apparatus is composed of image forming apparatus main body A, sheet humidifying device B and sheet finisher FS.

The image forming apparatus main body A has, on its upper part, automatic document feeder 1 and image reading section 2, and a lower part of the image forming apparatus main body A is composed of a printer section.

In the printer section, the numeral 3 represents a sheet storing section that stores sheets S. In image forming unit (printer engine) 5 that forms a toner image on photoreceptor 4 through an electrophotographic process to conduct charging, exposure and development for photoreceptor 4, an image is formed on sheet S and the image thus formed is fixed by fixing unit 6. In the fixing unit 6, heat roller 6b housing therein heat source 6a and pressure roller 6c form a nip portion that conveys sheet S, thus, sheet S is heated and pressed, while it is conveyed, so that toner may be fused, and an image is fixed on sheet S.

The sheet S is fed by first sheet feeding unit 3a from sheet storing section 3, then, is fed after being stopped temporarily at second sheet feeding device 3b, so that image forming is conducted, and the sheet S on which an image has been formed is ejected from an ejection outlet by ejection rollers 8.

As a conveyance path for sheet S, there are provided sheet feeding path 7 covering from sheet storing section 3 to image forming unit 5, conveyance path 9a covering from image forming unit 5 to conveyance path 9a through fixing unit 6 and sheet ejection rollers 8 and rear surface conveyance path 9b that is for reversing conveyance.

An image forming mode includes a one-side face-down ejection mode, a one-side face-up ejection mode, and a two-side mode. In the one-side face-down ejection mode, an image is formed on one side, and sheet S which has passed through the fixing unit 6 is conveyed by sheet ejection rollers 8 to be ejected after being reversed inside out by reverse processing.

In the one-side face-up ejection mode, an image is formed on one side, and sheet S which has been conveyed through conveyance path 9a is conveyed by sheet ejection rollers 8 to be ejected.

In the two-side mode, an image is formed on one side and sheet S which has passed through the fixing unit 6 travels downward to advance to rear surface conveyance path 9b, and is fed to sheet feeding path 7 again after being reversed inside out.

In the image forming unit 5, a reverse side image is formed on the reverse side of the sheet S thus fed again, and the sheet S on which the reverse side image has been formed passes through the fixing unit 6, and is conveyed by the sheet ejection rollers 8 to be ejected.

The numeral 10 represents an operation section, and various types of modes in image forming apparatus main body A and an output mode employing sheet finisher FS can be established by operations in the operation section 10.

Controller C1 arranged on the image forming apparatus main body A is connected to controller C2 of sheet humidifying device B and to controller C3 of sheet finisher FS through communication section C4.

Sheet S ejected from the image forming apparatus main body A is conveyed to the sheet finisher FS through sheet humidifying device B.

The sheet humidifying device B has therein first receiving and conveying section 100 that receives and conveys sheet S ejected from the image forming apparatus main body A, sheet humidifying section 120 that humidifies sheets, second receiving and conveying section 150 that receives and conveys sheet S ejected from the image forming apparatus main body A, first decurl section 160, second decurl section 170, third decurl section 180 and ejection and conveyance section 200 that ejects sheet S and delivers it to sheet finisher FS.

The sheet finisher FS is one that carries out various types of post processing for sheet S ejected from the image forming apparatus main body A, and it includes generically a punching and folding machine, a flat binding machine, a center folding machine, a gluing and bookbinding machine and a cutting machine.

A gluing and bookbinding machine will be explained typically as an embodiment of the sheet finisher FS.

The gluing and bookbinding machine is equipped with sheet introduction section 21, sheet ejection section 22, sheet bundle storing section 23, sheet bundle conveyance section 24, glue coating section 25, cover sheet supply section 26, cover sheet cutting section 27, cover sheet wrapping section (case binding section) 28 and aligning section 29.

Sheet S introduced to sheet introduction section 21 is gradually conveyed downward obliquely after being placed on sheet bundle storing section, and is held by holding member 241 of sheet bundle conveyance section 24. The holding member 241 rotates while holding sheet bundle Sa so that a surface (a spine) that conducts coating of glue may come to the lower side, and stops at a prescribed position. The glue coating section 25 applies glue on the spine of the sheet bundle Sa.

Cover sheet K stored in cover sheet supply section 26 is conveyed to cover sheet wrapping section 28 through cover sheet cutting section 27, and then, a trailing edge section of the cover sheet K is cut to a prescribed length by the cover sheet cutting section 27. A length to which the cover sheet K is cut is one wherein a thickness of a spine of sheet bundle Sa is added to a length equivalent to two sheets S in their traveling direction.

The cover sheet wrapping section 28 receives cover sheet K supplied from the cover sheet supply section 26 and conveys it to conduct positioning in the lateral direction by aligning section 29, after stopping at a prescribed position. The cover sheet wrapping section 28 causes cover sheet K to come in pressure contact with glue coating surface N of sheet bundle Sa for adhesion.

The cover sheet K is folded along a side edge of glue coating surface N of sheet bundle Sa, by a descent of a pressure member that faces a spine of sheet bundle Sa and by a movement of a pair of folding members which are bilaterally symmetrical arranged on the upper portion of the cover sheet wrapping section 28, thus, sheet bundle Sa on which cover sheets K are mounted respectively on a surface and the reverse thereof is formed.

After an end of the folding process for cover sheet K, the cover sheet wrapping section 28 descends to retract, and then, ejection belt 30 that has been retreated toward the outside in the width direction of cover sheet K together with retreating of aligning section 29 moves to the inner side in the width direction at the lower part of sheet bundle Sa to stop. After that, when interposing by holding member 241 is released, the sheet bundle Sa descends and stops at the position where a lower spine of the sheet bundle Sa comes in contact with an upper surface of ejection belt 30. The rotating ejection belt 30 sticks over sheet K on sheet bundle Sa and ejects a booklet which has been subjected to wrapping processing out of the apparatus.

### [Sheet Humidifying Device]

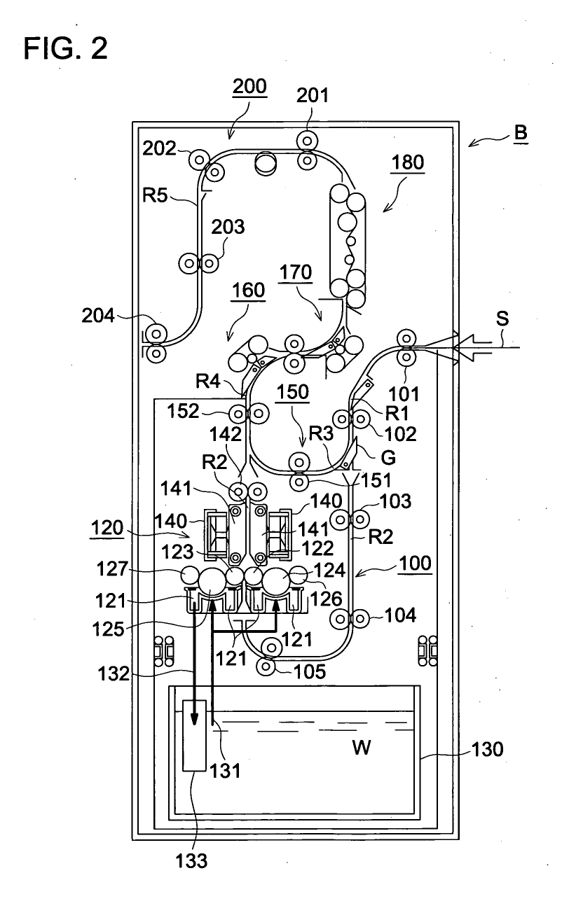

FIG. 2 is an overall diagram of sheet humidifying device B relating to an embodiment of the invention.

First receiving and conveying section 100 has conveyance path R1, sheet humidifying section 120 has conveyance path R2, second receiving and conveying section 150 has conveyance path R3, first to third decurl sections 160, 170 and 180 have conveyance path R4 and ejection and conveyance path 200 has conveyance path R5.

Conveyance paths R1 to R5 are formed by plural guide members as illustrated.

A part of conveyance path R1 is shared by first and second receiving and conveying sections 100 and 150.

Sheet S received by sheet humidifying device B is conveyed, through switching operations of switching gate G, to first decurl section 160 through first receiving and conveying section 100 and second receiving and conveying path 150 to be ejected through second decurl section 170, third decurl section 180 and ejection and conveyance section 200, or the sheet S is conveyed to sheet humidifying section 120 from the first receiving and conveying section 100, to be ejected out from sheet humidifying section 120 through second receiving and conveying section 150, first to third decurl sections 160, 170 and 180 and ejection and conveyance section 200.

In the first receiving and conveying section 100, the sheet S is conveyed by conveyance rollers 101 to 105 to be conveyed to sheet humidifying section 120.

In the sheet humidifying section 120, the sheet S is conveyed by humidifying rollers 122 and 123 and by conveyance rollers 142.

In the second receiving and conveying section 150, the sheet S is conveyed by conveyance rollers 101, 102, 151 and 152.

In the ejection and conveyance section 200, the sheet S is conveyed by conveyance rollers 201 to 204 and is ejected.

Next, each processing section of sheet humidifying device B will be explained.

### <Sheet Humidifying Section>

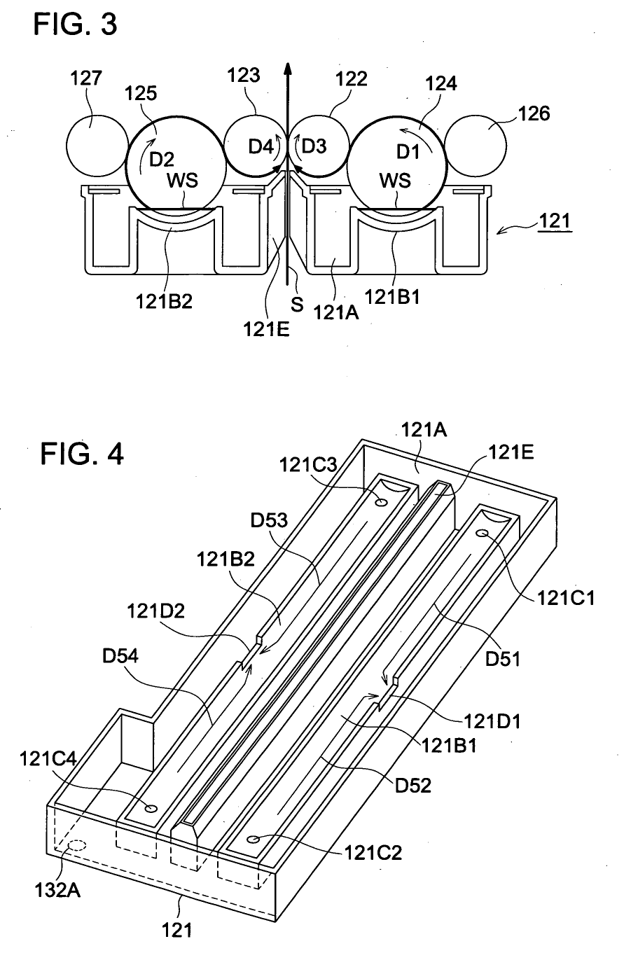

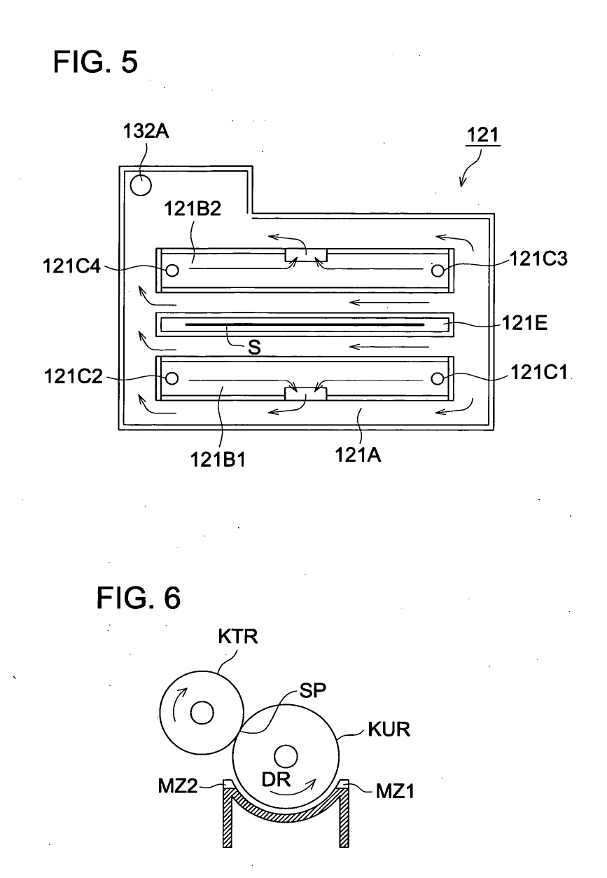

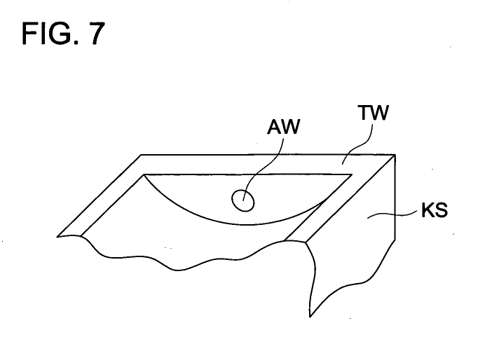

The structures and operations of sheet humidifying section 120 will be explained as follows, referring to FIGS. 1 to 5. FIG. 3 is a diagram showing the structure of a sheet humidifying section, FIG. 4 is a perspective view of a water vessel, and FIG. 5 is a plan view of water vessel 121.

Water vessel 121 storing therein water for humidifying sheets forms water tank 121A that is slightly longer than a maximum width (sheet length in the direction perpendicular to the conveyance direction) of sheet S to be conveyed.

In the water vessel 121, there are formed feed-water inlets and 121B2 which are arranged side by side.

The water-supply trays 121B1 and 121B2 form a chamber that stores water at the position that is higher than water tank 121A formed by water vessel 121.

As explained later, water stored in water-supply trays 121B1 and 121B2 overflows and falls to water tank 121A.

On the central portion of the water vessel 121, there is formed slit 121E through which the sheet S passes.

As shown in FIG. 5, sheet-passing sections which form water-supply trays 121B1 and 121B2 as well as slit 121E are formed t be in island-shapes in water tank 121A.

Two water-supply trays 121B1 and 121B2 respectively have circular-arc-shaped inner circumferential surfaces which respectively correspond to cylinder-shaped outer circumferential surfaces.

As is explained later, water is supplied from water-supply tube 131 to water-supply trays 121B1 and 121B2, and the overflow of water through drainage channels 121D1 and 121D2 keeps water level WS to be fixed constantly.

On the upper portions of the water-supply trays 121B1 and 121B2, there are arranged water-supply rollers 124 and 125 which are arranged to be away from an inner circumferential surface of sheet-supply tray 121B by a prescribed distance, and lower portions of water-supply rollers 124 and 125 are dipped in water stored in the water-supply trays 121B1 and 121B2.

Each of the water-supply rollers 124 and 125 is composed of a rubber roller wherein a rubber layer is formed on a metal core, and the water-supply rollers 124 rotates in the direction shown with arrow D1 and the water-supply rollers 125 rotates in the direction shown with arrow D2.

Humidifying roller 122 is arranged in a way to come in contact with water-supply roller 124, and humidifying roller 123 that is in contact with water-supply roller 125 is arranged, and the humidifying roller 122 and the humidifying roller 123 come in contact with each other.

Each of the humidifying roller 122 and the humidifying roller 123 is composed of a rubber roller wherein a rubber layer is formed on a metal core, and the humidifying roller 122 rotates in the direction shown with arrow D3 and the humidifying roller 123 rotates in the direction shown with arrow D4, thus, a circumferential surface of the humidifying roller 122 and a circumferential surface of the humidifying roller 123 moves upward in the same direction as is illustrated at their contact position, to interpose and convey sheet S.

Either one of the humidifying roller 122 and the humidifying roller 123 is driven by a driving source (unillustrated) to rotate as a driving roller, and another humidifying roller and water-supply rollers 124 and 125 are driven by the driving roller to rotate.

The numeral 126 represents a regulating member that comes in contact with water-supply roller 124, and 127 represents a regulating member that comes in contact with water-supply roller 125.

Each of the regulating members 126 and 127 is made of a metal cylinder body, and it is driven by water-supply rollers 124 and 125 to rotate.

The numeral 130 represents a reservoir, 131 represents supply-water pipe, 132 represents a drain pipe and 133 represents a filter.

Water W is supplied by a pump to water-supply trays 121B1 and 121B2 of water vessel 121 through water-supply pipe 131, and is returned to reservoir 130 from water vessel 121 through drain pipe 132.

Foreign substances such as paper dust mixed in water W in the course of humidifying sheets, are filtered by filter 133, and water W circulates between reservoir 130 and water vessel 121.

Humidification of sheet S is carried out as follows.

Sheet S is conveyed to sheet humidifying section 120 by conveyance roller 105, and passes through slit 121E to be conveyed by humidifying rollers 122 and 123.

Water W is supplied to outer circumferential surfaces of humidifying rollers 122 and 123 from water vessel 121 through water-supply rollers 124 and 125, and sheet S is humidified continuously in the process of conveyance accordingly.

On the outer circumferential surfaces of water-supply rollers 124 and 125, there are formed uniform water films which are further uniformalized by regulating members 126 and 127.

In the course of humidifying sheets, foreign substances such as paper dust adhere to humidifying rollers 122 and 123 from sheet S and further mix in water W, but foreign substances mixed in water W are filtered out by filter 133.

In FIGS. 3 and 5, arrows show directions of flows of water W in water-supply trays 121B1 and 121B2 and in water tank 121A.

On the water-supply tray 121B1, there are provided feed-water inlets 121C1 and 121C2 at both end portions in the conveyance-right-angled direction (direction perpendicular to the conveyance direction), and on the water-supply tray 121B2, there are provided feed-water inlets 121C3 and 121C4 at both end portions in the conveyance-right-angled direction.

The feed-water inlets 121C1 to 121C4 are preferably provided to be outside of the maximum width of sheet S to be conveyed.

Since excellent flows of water are formed inside the feed-water inlets 121C1 to 121C4, with respect to the conveyance-right-angled direction, adhesion of foreign substances to water-supply rollers 124 and 125 can be prevented by the aforesaid arrangement of the feed-water inlets 121C1 to 121C4.

The feed-water inlets 121C1 to 121C4 are formed on the upper end of water-supply tube 131 in FIG. 2.

Further, drainage channel 121D1 is formed at a central part in the conveyance-right-angled direction of a wall between water tank 121A and water-supply tray 121B1, and drainage channel 121D2 is formed at a central part in the conveyance-right-angled direction of a wall between water tank 121A and water-supply tray 121B2, respectively.

Water-supply trays 121B1 and 121B2 respectively have circular-arc-shaped inner circumferential surfaces which correspond to outer circumferential surfaces of water-supply rollers and 124 and 125, as stated above, and end portions thereof form edge portions of water-supply trays 121B1 and 121B2, as shown in FIG. 3.

The end portions are walls forming edge portions respectively of water-supply trays 121B1 and 121B2, and at central portions in the conveyance-right-angled direction, there are formed drainage channels 121D1 and 121D2.

A depth of each of water-supply trays 121B1 and 121B2 is about 6 mm, and a difference in levels between an upper edge of the wall and each of drainage channels 121D1 and 121D2 is about 2-3 mm.

Owing to the structure of water-supply trays 121B1 and 121B2 of this kind, water supplied from each of feed-water inlets 121C1 to 121C4 on the end portions flows toward the central portion as shown by arrows D51 to D54, to overflow through drainage channels 121D1 and 121D2 and falls in water tank 121A.

Water that has fallen is drained to drain pipe 132 from drainage channel 132A.

When drainage channels 121D1 and 121D2 are not provided, a position where water falls in water tank 121A from water-supply trays 121B1 and 121B2 is not fixed, and a flow path in water-supply trays 121B1 and 121B2 becomes irregular.

Therefore, in the course of humidifying sheets, foreign substances mixed in water adhere to various portions of water-supply trays 121B1 and 121B2, resulting in troubles that water films formed on humidifying rollers 122 and 123 become uneven.

By providing drainage channels 121D1 and 121D2, a flow path of water in each of water-supply trays 121B1 and 121B2 becomes constant, thus, foreign substances fall in water tank 121A without adhering to water-supply trays 121B1 and 121B2, and are ejected through drain pipe 132 to be collected in filter 133.

It is preferable that each of drainage channels 121D1 and 121D2 is provided at the central portion in the conveyance-right-angled direction, by considering how humidifying device B is installed.

By providing drainage channels 121D1 and 121D2 at the central portion, the drainage channels 121D1 and 121D2 easily function properly as drainage channels, a water level of water contained in water-supply trays 121B1 and 121B2 is not changed greatly, and uniform humidification is assured, even when the humidifying device B is installed obliquely to a certain extent.

In the illustrated example, drainage channel 121D1 is provided at an upstream side in rotational direction D1 of water-supply roller 124, when the drainage channel 121D1 is viewed from the position where the water-supply roller 124 delivers water to humidifying roller 122, namely, the position where the water-supply roller 124 comes in contact with the humidifying roller 122.

Under the condition of installment of drainage channel 121D1 of this kind, a flow of water W and foreign substances caused by rotation of the water-supply roller 124 causes foreign substances transferred from humidifying roller 122 to water-supply roller 124 to be ejected efficiently from the drainage channel 121D1, and forms a water flow shown with arrows D51 to D54, so that water W flows smoothly.

Arrangement of drainage channel 121D2 is also the same as the foregoing, and the drainage channel 121D2 is arranged at an upstream side in rotational direction D2 of water-supply roller 125, when the drainage channel 121D2 is viewed from the position where the water-supply roller 125 comes in contact with the humidifying roller 123.

Meanwhile, the drainage channel may also be provided at a downstream side in the rotational direction of water-supply rollers 124 and 125, in place of drainage channels 121D1 and 121D2 wherein the drainage channel is arranged at an upstream side as stated above, or in addition to drainage channels 121D1 and 121D2.

FIG. 6 shows an example wherein drainage channel on the upstream side MZ1 and drainage channel on the downstream side MZ2 are provided.

On both sides of water-supply tray 121B1, there are provided drainage channel on the upstream side MZ1 and drainage channel on the downstream side MZ2.

In the same way as in drainage channels 121D1 and 121D2 explained above, drainage channel MZ1 on the upstream side is arranged at the upstream side in the rotational direction DR of water-supply roller KUR, when viewed from the position where the humidifying roller KTR comes in contact with water-supply roller KUR, and drainage channel MZ2 on the upstream side is arranged on the downstream side in the rotational direction DR of water-supply roller KUR, when viewed from the position where the humidifying roller KTR comes in contact with water-supply roller KUR.

Since the drainage channel MZ1 on the upstream side is formed to be ahead of a water flow that is formed a rotation of water-supply roller KUR, circulation of water in a water-supply tray is made to be smooth, resulting in formation of a uniform water film on a water-supply roller.

Since the drainage channel MZ2 on the downstream side makes circulation of water W to be smooth and is arranged on the side close to the position of contact between water-supply roller KUR and humidifying roller KTR, it collects and ejects efficiently foreign substances carried by water-supply roller KUR.

Though feed-water inlets 121C1 to 121C4 are formed on bottom portions of water-supply trays 121B1 and 121B2 in the illustrated example, it is also possible to provide feed-water inlet AW on side wall TW at the edge portion of water-supply tray KS in the conveyance-right-angled direction.

Humidified sheet S is guided by a pair of guide members 141 to be conveyed upward.

At the position where sheet S is guided by a pair of guided members 141, there is conducted moisture conditioning wherein excessive humidity is removed from both sides of sheet S by a pair of fans 140.

<Decurl device>

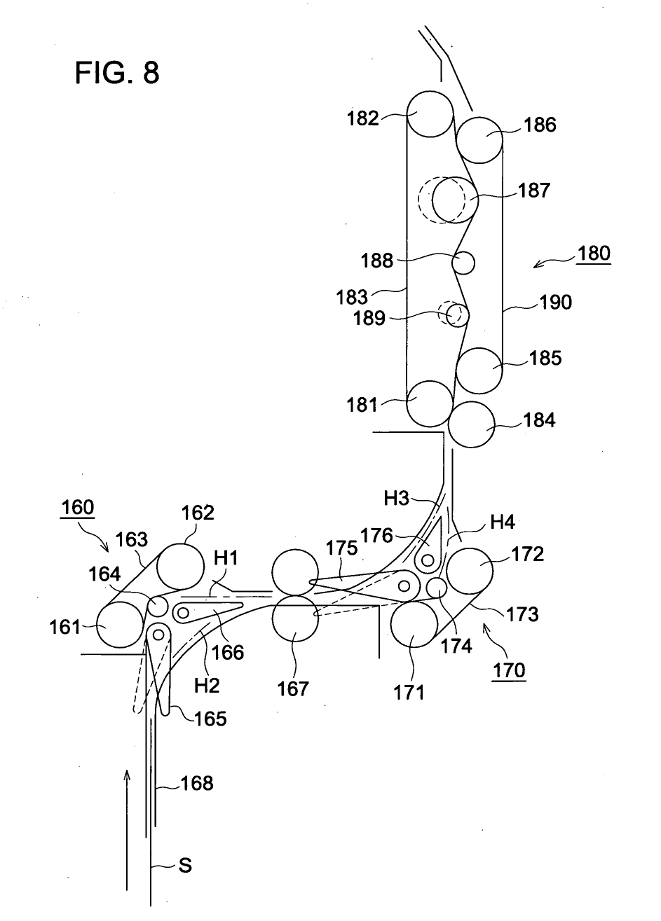

A decurl device will be explained, referring to FIG. 8.

A decurl device has therein first decurl section 160, second decurl section 170 and third decurl section 180.

In the first decurl section 160, belt 163 is entrained about a pair of rollers 161 and 162, and pressing roller 164 comes in contact with the belt 163.

As illustrated, the pressing roller 164 presses the belt 163 and the intermediate position between roller 161 and roller 162, and bends the belt 163.

As a result, there is formed conveyance path H1 that deviates sheet S to the right direction in the drawing by rollers 161 and 162, belt 163 and pressing roller 164.

The numeral 165 represents a switching gate that guides sheet S to switch to conveyance path H1 or to conveyance path H2, and sheet S is guided to conveyance path H1 when the switching gate is in a position shown with solid lines, while, the sheet S is guided to conveyance path H2 when the switching gate is in a position shown with dotted lines.

Sheet S guided to conveyance path H1 is bent by rollers 161 and 162, belt 163 and by pressing roller 164, so that a curl is corrected.

Sheet S guided to conveyance path H2 is not corrected in terms of curling, because it is conveyed through conveyance path H2 whose radius of curvature is large.

Sheet S is conveyed by conveyance roller 167 from decurl section 160 to decurl section 170.

In the second decurl section 170, belt 173 is entrained about a pair of rollers 171 and 172, and pressing roller 174 comes in contact with belt 173.

The pressing roller 174 presses the belt 173 at the intermediate position between roller 171 and roller 172, to bend the belt 173.

As a result, there is formed conveyance path H4 that deviates sheet S to the left direction in the drawing by rollers 171 and 172, belt 173 and by pressing roller 174.

The numeral 175 represents a switching gate that guides sheet S to switch to conveyance path H3 or to conveyance path H4, and sheet S is guided to conveyance path H4 when the switching gate is in a position shown with solid lines, while, the sheet S is guided to conveyance path H3 when the switching gate is in a position shown with dotted lines.

Sheet S guided to conveyance path H4 is bent by rollers 171 and 172, belt 173 and by pressing roller 174, so that a curl is corrected.

Sheet S guided to conveyance path H3 is not corrected in terms of curling, because it is conveyed through conveyance path whose radius of curvature is large.

In the third decurl section 180, belt 183 is entrained about rollers 181, 182, 187 and 189, while, belt 190 is entrained about rollers 185, 186 and 188.

As illustrated, rollers 181, 182, 185 to 189 are arranged so that belts 183 and 190 may meander.

As illustrated, belt 183 is in contact with belt 190, and the contact section interposes sheet S to convey it. The numeral 184 represents a conveyance roller that introduces sheets S to decurl section 180.

Belt 183 is entrained about rollers 187 and 189, namely, the rollers 187 and 189 are in contact with an inner circumferential surface of belt 183, and they press belt 183 from its outer circumferential surface side.

Belt 190 is entrained about roller 188, namely, roller 188 is in contact with an inner circumferential surface of belt 190 and presses belt 183 from its outer circumferential surface side.

Each of rollers 187 and 189 can be displaced between a solid line position and a dotted line position.

When rollers 187 and 189 are in the solid line positions, sheet S is bent toward the left direction and a curl is corrected, while, when they are in the dotted line positions, a curl is not corrected.

Further, when rollers 187 and 189 are in the solid line positions, sheet S is bent toward the right direction to correct a curl.

Third decurl section 180 corrects microscopic curls.

Namely, large curls are corrected in the first decurl section 160 and the second decurl section 170, while, residual microscopic curls are corrected in the third decurl section 180.

By controlling positions of switching gates 165 and 175, and rollers 187 and 189 depending on types of sheets, correction of curls in sheet S can be properly conducted.

In the present invention, a drainage channel that causes water to overflow is provided on a wall of water-supply tray that stores water to be supplied to a humidifier humidifying sheets, thus, a fixed flow path for water is formed in the water-supply tray, whereby, foreign substances are collected efficiently, and adhesion of foreign substances to the humidifier can be prevented.

As a result, uniform humidification for sheets can be kept for a long time.

What is claimed is:

1. A sheet humidifying device comprising:
(a) a humidifier having a pair of humidifying rollers which form a nip by being in contact with each other and humidify a sheet that passes through the nip; and
(b) a water supply tray which stores water to be supplied to the humidifier, having a wall forming a chamber that stores the water and a water outlet causing the water to overflow from the chamber, which is formed on the wall.

2. The sheet humidifying device of claim 1, wherein the chamber is extended in a sheet width direction perpendicular to a sheet conveyance direction, and the water outlet is formed at a center portion of the chamber in the sheet width direction.

3. The sheet humidifying device of claim 1, wherein the humidifier comprises a pair of water supply rollers soaked in the water of the water supply tray, which supply the water by being in contact with the humidifying rollers.

4. The sheet humidifying device of claim 3, wherein the water outlet is provided upstream of the water supply rollers in a rotation direction thereof with respect to a contact position between the humidifying rollers and the water supply rollers.

5. The sheet humidifying device of claim 3, wherein the water outlet is provided downstream of the water supply rollers in a rotation direction thereof with respect to a contact position between the humidifying rollers and the water supply rollers.

6. The sheet humidifying device of claim 1, wherein the water supply tray comprises a water inlet through which the water is supplied to the water supply tray.

7. The sheet humidifying device of claim 6, wherein the water inlet is provided outside a range where a sheet having a maximum width passes through.

8. The sheet humidifying device of claim 1, further comprising:
a vessel having the water supply tray and a tank which stores the water ejected from the water supply tray;
a reservoir in which water is reserved;
a supply-water pipe which supplies the water from the reservoir to the vessel; and
a drain pipe which ejects the water from the vessel to the reservoir.

9. An image forming apparatus comprising:
a main body of the image forming apparatus; and
the sheet humidifying device of claim 1 which humidifies a sheet discharged from the main body of the image forming apparatus.
